(19) United States
(12) Patent Application Publication
(10) Pub. No.: US 2026/0244969 A1
(43) Pub. Date: Aug. 20, 2026

(54) Quantum computing using a trapped-ion array and optical potentials

(71) Applicants: QUANTUM ART LTD., Nes Ziona (IL); YEDA RESEARCH AND DEVELOPMENT CO. LTD., Rehovot (IL)

(72) Inventors: David Schwerdt, Rehovot (IL); Yotam Shapira, Rehovot (IL); Nadav Priel, Mazkeret Batya (IL); Avram Gross; Ayelet Zalic, Rehovot (IL); Nitzan Akerman, Rehovot (IL); Adiel Stern, Tel-Aviv (IL); Amit Ben Kish, Givat Ela (IL); Roee Ozeri, Rehovot (IL); Yanay Florshaim, Even Shmuel (IL); Lee Peleg, London (GB); Gadi Afek, Nes Ziona (IL)

(21) Appl. No.: 19/164,232

(22) PCT Filed: Mar. 5, 2024
(86) PCT No.: PCT/IB2024/052100

§ 371 Date: Sep. 11, 2025

Related U.S. Application Data
(60) Provisional application No. 63/490,007, filed on Mar. 14, 2023.
(60) Provisional application No. 63/594,976, filed on Nov. 1, 2023.
(60) Provisional application No. 63/595,349, filed on Nov. 2, 2023.

(51) Int. Cl. G06N 10/40

(52) U.S. Cl. CPC G06N 10/40

(57) ABSTRACT

A method for quantum computing includes defining a quantum computation including a sequence of computing steps in which multiple quantum operations are performed in parallel in each step. An array of ions (40) in an ion trap (24) is segmented into first computational segments (110) including groups of adjacent ions separated by first barrier ions (112) between the groups, by optically confining the barrier ions. Excitation fields are applied to the ions in the computational segments so as to cause the groups of ions to carry out the quantum operations in a first step in the sequence. After completing the first step, the array is reconfigured into second computational segments by optically confining second barrier ions, at least some of which are different from the first barrier ions, while retaining at least some coherence from the first computational segments to the second computational segments.

### CROSS-REFERENCE TO RELATED APPLICATION

This application claims the benefit of U.S. Provisional Patent Application 63/490,007, filed Mar. 14, 2023; U.S. Provisional Patent Application 63/594,976, filed Nov. 1, 2023; and U.S. Provisional Patent Application 63/595,349, filed Nov. 2, 2023. All these related applications are incorporated herein by reference.

### FIELD

The present invention relates generally to quantum computing, and particularly to large-scale quantum computations using trapped-ion arrays.

### BACKGROUND

Quantum computers apply principles of quantum physics in solving computational problems and have the potential to perform certain computations far more efficiently than existing digital computers. The basic building block of a quantum computer is the qubit. Quantum computers perform digital quantum computations using qubits and gates that operate the qubits, including single-qubit, two-qubit, and multi-qubit gates, as well as analog quantum simulations. The terms “quantum computer” and “quantum computation,” as used in the present description and in the claims, should be understood as encompassing all sorts of quantum information processing, including both gate-based quantum computations and analog quantum simulations.

Trapped-ion systems, in which individual atomic ions serve as qubits, hold promise as a scalable, reliable platform for quantum computing and quantum simulations. In a trapped-ion system, the individual atomic ions are typically trapped by electromagnetic fields in an ultra-high vacuum and are cooled to their motional ground states. The internal electronic levels of the ions, as well as the motion of the ions in the trap, are controlled with high precision using lasers, microwaves, and/or radio-frequency (RF) fields. To perform digital quantum computations, gates are applied to the internal and motional states of the atomic ions by driving fields of the appropriate frequencies, amplitudes, phases, and duration.

In trapped-ion systems, entanglement gates are typically generated by driving the ions with electromagnetic fields that create phonon-mediated qubit-qubit interactions. Aspects of driving multi-qubit gates in a trapped ion array are described, for example, in PCT International Publication WO 2023/105434, whose disclosure is incorporated herein by reference.

The prevalent approach to quantum computing is to break down algorithms into a concatenation of single-qubit and two-qubit gates. Multi-qubit gates made up of three or more qubits, however, have also been proposed. For example, Shapira et al. describe gates of this sort in an article entitled “Theory of robust multiqubit nonadiabatic gates for trapped ions,” published in Physical Review A 101, 032330 (2020), which is incorporated herein by reference.

Scaling up the number of qubits in multi-qubit gates, while retaining high-fidelity and high-speed operations, is challenging. Specifically, designing multi-qubit entanglement gates in long ion crystals of hundreds of ions involves a hard optimization problem, rendering scaling up the number of qubits a conceptual challenge as well. Shapira et al. describe a method that reduces the computational challenge, effectively allowing for a polynomial-time design of fast and programmable entanglement gates, in “Fast design and scaling of multi-qubit gates in large-scale trapped-ion quantum computers,” published in arXiv:2307.09566 (2023), which is incorporated herein by reference.

### SUMMARY

Embodiments of the present invention that are described hereinbelow provide improved systems and methods for quantum computing using arrays of trapped ions.

There is therefore provided, in accordance with an embodiment of the invention, a method for quantum computing, which includes trapping an array of ions in an ion trap and defining a quantum computation including a sequence of computing steps, each step including multiple quantum operations to be performed in parallel. The array is segmented into first computational segments including respective groups of adjacent ions separated by first barrier ions between the groups, by optically confining the barrier ions. Excitation fields are applied to the ions in the first computational segments so as to cause the groups of the adjacent ions in the first computational segments to carry out the quantum operations in a first step in the sequence. After completing the quantum operations in the first step, the array is reconfigured into second computational segments by optically confining second barrier ions, at least some of which are different from the first barrier ions, while retaining at least some coherence from the first computational segments to the second computational segments. The excitation fields are applied to the ions in the second computational segments so as to cause the groups of the adjacent ions in the second computational segments to carry out the quantum operations in a second step in the sequence using at least some of the retained coherence. The steps of reconfiguring the array into further computational segments and applying the excitation fields to the further computational segments are repeated to complete the quantum computation.

In a disclosed embodiment, upon completing the quantum computation, respective states of at least some of the ions are measured.

In some embodiments, trapping the array of ions includes forming a linear array of the ions. Alternatively, trapping the array of ions includes forming a two-dimensional array of the ions. Further alternatively, trapping the array of ions includes forming a three-dimensional array of the ions.

In some embodiments, optically confining the barrier ions includes applying optical tweezers to the barrier ions. In disclosed embodiments, applying the optical tweezers includes confining the barrier ions using laser beams that are tuned to apply optical attractive forces or repulsive forces to the barrier ions.

In some embodiments, the method includes performing a mid-circuit measurement by sensing a state of one or more of the ions following at least the first step in the sequence. In a disclosed embodiment, applying the excitation fields to the ions in the second computational segments includes using information contained in the sensed state in the mid-circuit measurement in defining the quantum operations to be performed in subsequent steps. In one embodiment, the method includes applying an error correction to the quantum computation based on the mid-circuit measurements. Additionally or alternatively, performing the mid-circuit measurement includes sensing the state of one or more of the barrier ions. Typically, reconfiguring the array into the second computational segments following the mid-circuit measurement is completed in a duration shorter than 20 ms, and possibly shorter than 10 ms.

In the disclosed embodiments, applying the excitation fields includes directing beams of coherent optical radiation to excite transitions of the ions in the computational segments. The transitions may include internal transitions and/or motional transitions of the ions in the computational segments.

Additionally or alternatively, applying the excitation fields includes setting respective spectra of the beams and pulse times to drive the ions to complete the quantum operations in each step. Typically, optically confining the barrier ions reduces a crosstalk between neighboring computational segments in the array. In some embodiments, setting the respective spectra and pulse times includes estimating the crosstalk between the neighboring computational segments in the array, and choosing the respective spectra and pulse times to compensate for the estimated crosstalk. In a disclosed embodiment, choosing the respective spectra and pulse times includes defining a desired level of the crosstalk and selecting the spectra and pulse times to reduce the estimated crosstalk to below the desired level while maximizing the desired computational operation performances of each segment.

In some embodiments, the array of ions in the ion trap has an inter-ion characteristic frequency ν, and optically confining the barrier ions includes applying optical radiation to the barrier ions with an intensity sufficient to trap the barrier ions optically with an optical trapping frequency ωₒₜₚ>1.5ν, or possibly ωₒₜₚ>1.8ν. In a disclosed embodiment,

$$v = \sqrt{\frac{{e}^{2}}{4 π {ϵ}_{0} m {d}^{3}}} ,$$

wherein e is the electron charge, ϵ₀ is the vacuum permittivity, m is the mass of each ion, and d is the inter-ion distance in the array.

In another embodiment, the array of ions in the ion trap has an inter-ion characteristic frequency ν, and optically confining the barrier ions includes applying optical radiation to a group of the barrier ions between adjacent computational segments with an intensity sufficient to confine the barrier ions optically with respective optical trapping frequencies ωₒₜₚ, such that a sum of the respective optical trapping frequencies is greater than 2ν.

In some embodiments, optically confining the barrier ions reduces the rate of heating of the ions in the array. Typically, the rate of heating is determined primarily by respective sizes of the computational segments, rather than by a number of the ions in the array.

In some embodiments, applying the excitation fields includes exciting motional modes of the array of ions having respective motional frequencies, and optically confining the barrier ions groups the motional frequencies into bands having respective mean frequencies and bandwidths, such that the bandwidth of each band is smaller than a difference between the mean frequencies of adjacent bands. In disclosed embodiments, optically confining the barrier ions reduces the bandwidths to no more than 20% of the difference between the mean frequencies of adjacent bands. In other embodiments, optically confining the barrier ions reduces the bandwidths to no more than 10% of the difference between the mean frequencies of adjacent bands, or even to no more than 5% of the difference between the mean frequencies of adjacent bands. In the disclosed embodiments, applying the excitation fields includes performing multi-qubit gate operations in at least some of the computational segments.

In some embodiments, at least some of the computational segments created by segmenting the array each include at least ten of the ions or even at least twenty of the ions.

Additionally or alternatively, applying the excitation fields includes executing at least some of the quantum operations over gates that include four or more of the ions or even over gates that include twelve or more of the ions.

In some embodiments, reconfiguring the array into the second computational segments while retaining the at least some coherence includes entangling the ions in the second computational segments with the ions in the first computational segments. In a disclosed embodiment, the array includes n ions, and entangling the ions in the second computational segments includes controllably entangling at least 70% of the ions in the computational segments in the array, over a number s of the reconfiguring steps such that s<0.2*n.

In some embodiments, reconfiguring the array into the second computational segments is completed in a duration shorter than 10 ms, or possibly shorter than 1 ms, or shorter than 100 μs, or shorter than 10 μs, or even shorter than 1 μs.

In one embodiment, defining the quantum computation includes applying a quantum error correction code over the sequence of computing steps. In another embodiment, defining the quantum computation includes carrying out a quantum simulation over the sequence of computing steps.

There is also provided, in accordance with an embodiment of the invention, a method for quantum computing, which includes trapping an array of ions in an ion trap and segmenting the array into computational segments including respective groups of adjacent ions separated by barrier ions between the groups, by optically confining the barrier ions. A quantum computation is defined, including multiple quantum operations to be performed in parallel over the computational segments. The quantum operations define target entanglement phases among the ions in each segment. A crosstalk between neighboring computational segments in the array is estimated. Respective spectra of excitation fields for driving the ions to the target entanglement phases are computed while compensating for the estimated crosstalk. The excitation fields with the respective spectra are applied to the ions in the computational segments so as to carry out the quantum operations.

In some embodiments, compensating for the estimated crosstalk decreases an infidelity of the quantum operations to less than 0.1, or possibly to less than 0.01, or less than 0.001, or even less than 0.0001.

In some embodiments, segmenting the array gives rise to motional modes within the computational segments having respective vibrational frequencies grouped in frequency bands, with a minimal spacing Δf between the frequency bands, and applying the excitation fields drives the ions to the target entanglement phases within a time that is less than 50/Δf.

In disclosed embodiments, optically confining the barrier ions reduces a crosstalk between neighboring computational segments in the array to yield a residual crosstalk, and compensating for the estimated crosstalk includes compensating for the residual crosstalk.

In some embodiments, applying the excitation fields comprises directing beams of coherent optical radiation to excite transitions of the ions in the computational segments. In a disclosed embodiment, computing the respective spectra includes finding initial spectra and pulse times that will lead to zero entanglement phases among the ions, and applying a process of optimization beginning from the initial spectra and pulse times to find a target vector of the complex amplitudes that will lead to the target entanglement phases. Typically, applying the process of optimization includes mitigating the estimated crosstalk as a part of the process of optimization, thereby increasing a fidelity of the quantum computation.

There is additionally provided, in accordance with an embodiment of the invention, a method for quantum computing, which includes trapping an array of ions in an ion trap, which is configured such that the array of ions has an inter-ion characteristic frequency ν. The array is segmented into computational segments including respective groups of adjacent ions separated by barrier ions between the groups, by optically confining the barrier ions with an intensity sufficient to trap the barrier ions optically with an optical trapping frequency ωₒₜₚ>1.5ν. A quantum computation is defined, including multiple quantum operations to be performed in parallel over the computational segments. Excitation fields are applied to the ions in the computational segments so as to cause the groups of the adjacent ions to carry out the quantum operations.

In some embodiments, applying the excitation fields includes exciting motional modes of the array of ions with vibrational frequencies centered around basic trapping frequencies ωₜᵣₐₚ of the ion trap. In a disclosed embodiment, optically confining the barrier ions includes applying optical radiation to a group of the barrier ions between adjacent computational segments with an intensity sufficient to trap the barrier ions optically with respective optical trapping frequencies ωₒₜₚ, such that a sum of the respective trapping frequencies is greater than ωₜᵣₐₚ.

There is further provided, in accordance with an embodiment of the invention, a system for quantum computing, including an ion trap, which is configured to hold an array of ions in respective positions along an array axis. A radiation source is configured to apply optical fields to segment the array into multiple computational segments including respective groups of adjacent ions separated by barrier ions between the groups, by optically confining the barrier ions, and is further configured to apply excitation fields to the ions in the computational segments so as to cause the groups of the adjacent ions in the computational segments to carry out quantum operations. A controller is configured to receive a definition of a quantum computation including a sequence of computing steps, each step including multiple quantum operations to be performed in parallel.

The controller is configured to control the radiation source to segment the array into first computational segments by optically confining first barrier ions and to apply the excitation fields to the ions in the first computational segments so as to cause the groups of the adjacent ions in the first computational segments to carry out the quantum operations in a first step in the sequence. After completing the quantum operations in the first step, the array is reconfigured into second computational segments by optically confining second barrier ions, at least some of which are different from the first barrier ions, while retaining at least some coherence from the first computational segments to the second computational segments. The excitation fields are applied to the ions in the second computational segments so as to cause the groups of the adjacent ions in the second computational segments to carry out the quantum operations in a second step in the sequence using at least some of the retained coherence. The controller is configured to repeat the steps of reconfiguring the array into further computational segments and applying the excitation fields to the further computational segments to complete the quantum computation.

There is moreover provided, in accordance with an embodiment of the invention, a system for quantum computing, including an ion trap, which is configured to hold an array of ions in respective positions along an array axis. A radiation source is configured to apply optical fields to segment the array into multiple computational segments including respective groups of adjacent ions separated by barrier ions between the groups, by optically confining the barrier ions, and is further configured to apply excitation fields to the ions in the computational segments so as to cause the groups of the adjacent ions in the computational segments to carry out quantum operations. A controller is configured to receive a definition of a quantum computation including multiple quantum operations to be performed in parallel over the computational segments. The quantum operations define target entanglement phases among the ions in each segment, wherein the definition includes respective spectra of excitation fields for driving the ions to the target entanglement phases while compensating for an estimated crosstalk between neighboring computational segments in the array. The controller is configured to drive the radiation source to apply the excitation fields with the respective spectra to the ions in the computational segments so as to carry out the quantum operations.

There is furthermore provided, in accordance with an embodiment of the invention, a system for quantum computing, including an ion trap, which is configured to hold an array of ions such that the array of ions has an inter-ion characteristic frequency ν. A radiation source is configured to apply optical fields to segment the array into multiple computational segments including respective groups of adjacent ions separated by barrier ions between the groups, by optically confining the barrier ions with an intensity sufficient to trap the barrier ions optically with an optical trapping frequency ωₒₜₚ>1.5ν, and is further configured to apply excitation fields to the ions in the computational segments so as to cause the groups of the adjacent ions in the computational segments to carry out quantum operations. A controller is configured to receive a definition of a quantum computation including multiple quantum operations to be performed in parallel over the computational segments, and to drive the radiation source to apply excitation fields to the ions in the computational segments so as to cause the groups of the adjacent ions to carry out the quantum operations. As a final computational step, state detection may be performed.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a quantum computing system, in accordance with an embodiment of the invention;

FIG. 2 is a block diagram that schematically illustrates an array of trapped ions configured as qubits in a quantum computer, in accordance with an embodiment of the invention;

FIG. 3 is a schematic side view of a multi-beam optical confinement and excitation subsystem used in a quantum computing system, in accordance with an embodiment of the invention;

FIG. 4 is a schematic detail view of a multi-beam generation and modulation module, in accordance with an embodiment of the invention;

FIG. 5 is a block diagram that schematically illustrates a sequence of quantum computing steps performed using an array of trapped ions, in accordance with an embodiment of the invention;

FIG. 6A is a flow diagram that schematically illustrates a method for mid-circuit measurement within a sequence of quantum computing steps, in accordance with an embodiment of the invention;

FIG. 6B is an atomic level diagram (not to scale) that schematically shows details of energy levels used in the mid-circuit measurement of FIG. 6A;

FIG. 7 is a plot that schematically shows changes in axial mode frequencies of an array of trapped ions as a function of an optical trapping potential that is applied in segmenting the array, in accordance with an embodiment of the invention;

FIG. 8 is a plot that schematically shows radial mode frequencies in a segmented array of trapped ions, in accordance with an embodiment of the invention;

FIG. 9 is a flow chart that schematically illustrates a method for selecting parameters to drive multi-qubit gates in a segmented array of trapped ions, in accordance with an embodiment of the invention;

FIG. 10 is a plot that schematically shows the infidelity of a segmented array of trapped ions as a function of an optical trapping potential that is applied in segmenting the array, with and without compensation for residual crosstalk, in accordance with an embodiment of the invention;

FIGS. 11A, 11B and 11C are schematic frontal views of partitioned two-dimensional arrays of trapped ions, in accordance with embodiments of the invention; and.

FIG. 11D is a schematic frontal view of a partitioned three-dimensional array of trapped ions, in accordance with an embodiment of the invention.

### DETAILED DESCRIPTION

### Overview

Trapped ions have ideal properties to be used as qubits for quantum computing: They feature long coherence times, efficient state preparation and detection techniques, and a high degree of connectivity. A quantum register of thousands of qubits can be formed, for example, using an array of equally spaced ions (also referred to as an “ion-crystal”) in a linear RF Paul trap.

There are practical issues associated with large ion-crystals, however, that have impeded progress in this direction. One problem is that as the number of ions N in the crystal increases, heating of the motional modes of the ions due to electric field noise increases. The resulting heating rates reduce the fidelity of qubit operations and can destabilize the ion-crystal. Another problem in large ion-crystals is spectral crowding: As the size of the crystal increases, the frequency difference between adjacent motional modes decreases. For large ion-crystals with a dense mode spectrum, it becomes increasingly difficult to address individual modes and thus achieve the desired qubit couplings with high fidelity. Moreover, there is strong evidence that the minimum achievable gate time is limited by the smallest frequency spacing among the motional modes, which decreases with increasing N as noted above, making large ion-crystals prohibitively slow for quantum computations.

In response to these challenges, embodiments of the present invention that are described herein provide a scalable architecture for quantum computing based on trapped-ion qubits, which maintains the advantages of a long ion-crystal while circumventing the problems noted above. In the disclosed embodiments, an arbitrarily long ion-crystal is segmented into computational segments by dynamic application of optical potentials. These embodiments use high-intensity optical beams to confine the movement of selected barrier ions between the computational segments. (For example, “optical tweezers” may be applied to confine the barrier ions using laser beams that are tuned to apply optical attractive forces or repulsive forces to the barrier ions.) In this way, the motional mode structure of the ion-crystal is modified such that heating rates reflect only the segment size, and not N. Using this approach, programmable, high-fidelity multi-qubit entangling gates can be implemented independently within all the segments simultaneously.

This dynamic optical segmentation scheme also facilitates multi-step quantum computations, in which the choice of barrier ions and computational segments can change from step to step. The switching between array segmentation configurations is carried out while maintaining the coherence already accumulated within each segment and is fast enough so that at least some coherence of the qubit states can be retained and carried over from segment to segment in successive computational steps. The reconfiguration itself does not introduce additional incoherence.

In some embodiments, mid-circuit measurements are integrated with the reconfiguration of computational segments from step to step. These mid-circuit measurements can be used, for example, to support quantum error correction (QEC) techniques. Alternatively or additionally, the multi-step computational schemes that are described herein, with reconfiguration of computational segments, can be applied in quantum simulations.

Although the embodiments that are described hereinbelow relate mainly to linear arrays of trapped ions, i.e., one-dimensional ion-crystals, the principles of the present invention are also applicable, mutatis mutandis, to two-dimensional and three-dimensional trapped ion arrays. Furthermore, the present methods for quantum computing using segmented ion-crystals may be integrated with other multi-trap techniques that are known in the art for scale-up of quantum computations, such as photonic interconnects among ion chains; quantum charge-coupled device architectures (including various ion shuttling schemes); and two-dimensional arrays of traps that use dipole-dipole interactions for entanglement. All such alternative configurations and implementations are considered to be within the scope of the present invention.

The embodiments of the present invention that are described hereinbelow provide a method for quantum computing using an array of ions in an ion trap. A quantum computation comprising a sequence of computing steps is defined, in which each step comprises multiple quantum operations to be performed in parallel. In each step, the array is segmented into computational segments comprising respective groups of adjacent ions by optically confining barrier ions between the groups. Excitation fields are applied to the ions in the computational segments so as to cause the groups of ions in the computational segments to carry out the quantum operations in the current step in the sequence.

After completing the quantum operations in each such step, the array is reconfigured into different computational segments for the next step by optically confining a new set of barrier ions, at least some of which can be different from the barrier ions in the previous step. The new computational segments that are defined by the new barrier ions retain at least some coherence from the previous computational segments. Excitation fields are applied to the ions in the new computational segments so as to cause the groups of the ions in these computational segments to carry out the quantum operations in the next step in the sequence, using at least some of the retained coherence.

These steps of reconfiguring the array into new computational segments and applying the excitation fields to the ions in the new computational segments are repeated until the quantum computation is completed. Typically, upon completing the quantum computation, the respective states of at least some of the ions are measured to read out the results of the quantum computation.

To achieve high computational fidelity, in this sort of segmented computational scheme, it is important that the barrier ions be strongly trapped, so that crosstalk between neighboring segments, due to vibrations transmitted through the barrier ions, is reduced to an acceptable level, and the vibrational modes within each segment are well separated. Typically, an array of trapped ions will have a basic inter-ion interaction frequency ν, which is determined by the characteristics of the ion species of choice and the distance between the ions. For example, this frequency can be expressed as

$$v = \sqrt{\frac{{e}^{2}}{4 {πϵ}_{0} m {d}^{3}}} ,$$

for identical ions with charge e, wherein e is the electron charge, ϵ₀ is the vacuum permittivity, m is the mass of the ions, and d is the inter-ion distance of an equidistant array. At the same time, the intensity of the optical beams that are applied to optically confine the barrier items gives rise to a corresponding local optical trapping frequency ωₒₜₚ, which is proportional to the optical field strength. The relation between ωₒₜₚ and ν determines the levels of mode separation and crosstalk.

Thus, in some embodiments, the parameters of the ion trap and the optical confinement beams are chosen so that ωₒₜₚ>1.5ν, to provide clear separation of vibrational modes and low residual crosstalk. Desirably, the optical intensity may be even greater, for example ωₒₜₚ>1.8ν, or more, and is optimal at ωₒₜₚ=2ν. Optically confining the barrier ions in this manner also reduces the rate of heating of the ions in the array, so that the rate of heating is determined primarily by respective sizes of the computational segments, rather than by the total number of the ions in the array.

Strong optical confinement of the barrier ions reduces the crosstalk between neighboring computational segments sufficiently so that the residual crosstalk is typically no more than a few percent. This residual crosstalk, however, may still be too high to achieve the desired level of fidelity in quantum computations performed on the ion array. To compensate for this residual crosstalk in some embodiments of the present invention, the spectra and possibly the pulse times of the excitation fields are adjusted to compensate for the effects of the residual crosstalk. (The term “spectra” is used in the present description and in the claims to mean the frequencies, magnitudes, and phases of the excitation fields that are applied to the ions in the computational segments. In general, each ion may be excited by its own, respective spectrum, which may be different from the spectra used to excite the other ions.)

To achieve these favorable spectral qualities, some embodiments provide a method for choosing the spectra to be used in carrying out multi-segment quantum computations, i.e., computations in which multiple quantum operations are to be performed in parallel over computational segments of an array of trapped ions, which are separated by barrier ions. The quantum operations define a target entanglement phase among the ions in each segment. The crosstalk between neighboring computational segments in the array is estimated, and the respective spectra of excitation fields that are to be used in driving the ions to the target entanglement phase in each segment are computed while compensating for the estimated crosstalk. These excitation fields, with the respective spectra, are applied to the ions in the computational segments to carry out the quantum operations.

Compensating for the estimated crosstalk typically reduces the infidelity of the quantum operations to less than 0.1. In some embodiments, a process of optimization is applied in choosing the spectra of the excitation fields so as to mitigate residual crosstalk. By appropriate optimization of the spectra, over a sufficient number of computational steps, the infidelity may be reduced to less than 0.01, or even less than 0.001, and possibly, with sufficient computational effort and careful control of the excitation parameters, to less than 0.0001.

In some embodiments, the respective spectra to be applied to the ions are computed by finding initial non-trivial spectra and pulse times that will lead to zero entanglement phases among the ions. A process of optimization is then applied, beginning from the initial spectra, to find a target set of spectral components, amplitudes and phases that will lead to the desired target entanglement phases. This process of optimization includes mitigating the estimated crosstalk as a part of the process, thereby increasing the fidelity of the quantum computation.

### System Description

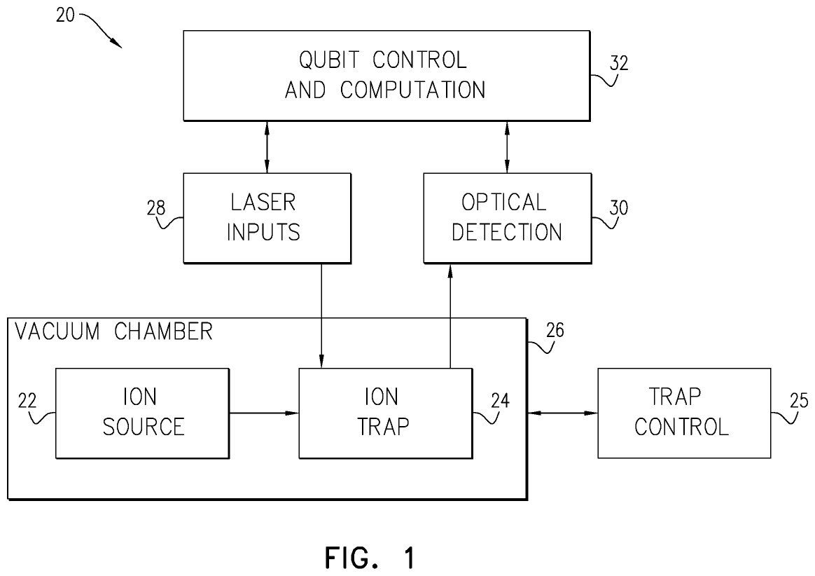

FIG. 1 is a block diagram that schematically illustrates a quantum computing system 20, in accordance with an embodiment of the invention. System 20 is presented as a non-limiting example of an application environment in which arrays of excitation beams and confinement beams can be used. Although the examples described below relate to linear arrays of trapped ions, the principles of the present embodiments may similarly be applied, mutatis mutandis, to two- and three-dimensional arrays.

In this example embodiment, an atom source 22 injects a flow of neutral atoms, such as atoms of calcium, into a vacuum chamber 26 at ultra-high vacuum. A radiation source 28 directs multiple beams of radiation into vacuum chamber 26, including a beam that is tuned to ionize the atoms injected by source 22. (In the present example, as noted above, system 20 is assumed to be based on electronic transitions, and radiation source 28 is assumed to comprise lasers emitting beams of coherent radiation; but ionization detection and tweezer beams, for example, may alternatively be carried out using an incoherent beam.) The resulting atomic ions are captured in an ion trap 24, such as a Paul trap, which uses RF fields to confine the ions along a specified axis within vacuum chamber 26, under the control of a trap controller 25. A magnetic field may also be applied to ion trap 24 to separate the different spin components of the electronic states of the ions into Zeeman levels.

An electronic qubit control and computation processor 32 drives radiation source 28 to direct and adjust additional beams toward the trapped ions in order to perform quantum computational operations and then read out the computational results. Typically, the results are read out by tuning a laser beam to an absorption line that involves one of the qubit states and then measuring the resulting fluorescent emission using an optical detector 30. Each step in the present example is defined by appropriate program code, using a single gate or multiple gates in parallel, and may include redefining the groups of ions making up the registers on which the gates operate at each of the steps. Alternatively, a sequence of operations on groups of ions may be defined and applied in order to perform quantum simulations.

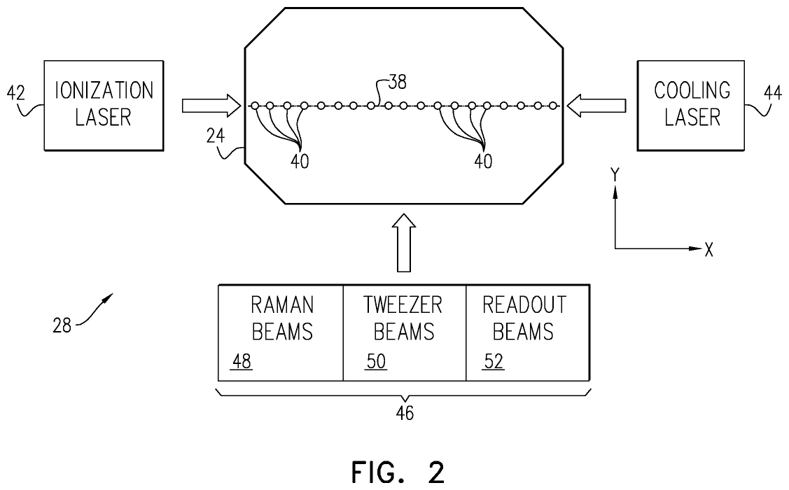

FIG. 2 is a block diagram that schematically illustrates an array of trapped ions 40 configured as qubits in a quantum computer, such as in system 20, in accordance with an embodiment of the invention. Radiation source 28 (FIG. 1), provides several different laser beam inputs to ion trap 24 for different purposes. An ionization laser 42 ionizes the atoms output by atom source 22 to create ions 40, which are held in the trap. Additional cooling lasers 44 cool the ions to their electronic and motional ground states, by pumping appropriate state transitions of the ions while detuning the laser frequencies to engender mechanisms of Doppler cooling, sideband cooling, polarization gradient cooling, cooling by electrically-induced transparency (EIT), and/or other methods of cooling that are known in the art.

The cooled ions 40 are held in a linear array along an axis 38 by the electromagnetic fields within trap 24. Coulomb repulsion between ions 40 and trapping fields applied by trap 24 determine the equilibrium distance between the ions, as well as the phonon frequencies {νₙ} of the normal vibrational modes of motion of ions 40 in the array, including both transverse and longitudinal modes of vibration. These normal vibrational modes give rise to vibrational sidebands of the optical transition frequencies between the states of ions 40, which are used in quantum computations.

For the purposes of defining and operating multi-qubit gates (including two, three, or larger numbers of qubits), as well as single-qubit gates, radiation source 28 (FIG. 1) comprises an excitation source 46, comprising one or more lasers, which directs beams of radiation at multiple different frequencies to impinge on ions 40 from various spatial directions. The beams may all be generated by the same laser, with appropriate amplitude, frequency, and phase modulation, or by multiple different lasers. Among these beams are Raman beams 48 and tweezer beams 50. Tweezer beams 50 are tuned to confine selected ions 40, referred to herein as barrier ions, using high-intensity optical fields. Application of the tweezer beams thus defines computational segments, also referred to as multi-qubit registers, between the confined ions. The wavelength of tweezer beams 50 may be chosen and tuned to confine the barrier ions by applying either optical attractive forces or repulsive forces to the barrier ions. Raman beams 48, also referred to as excitation beams, are tuned to coherently excite and manipulate internal and motional transitions of ions 40 within these multi-qubit registers to drive gate operations for carrying out quantum computations.

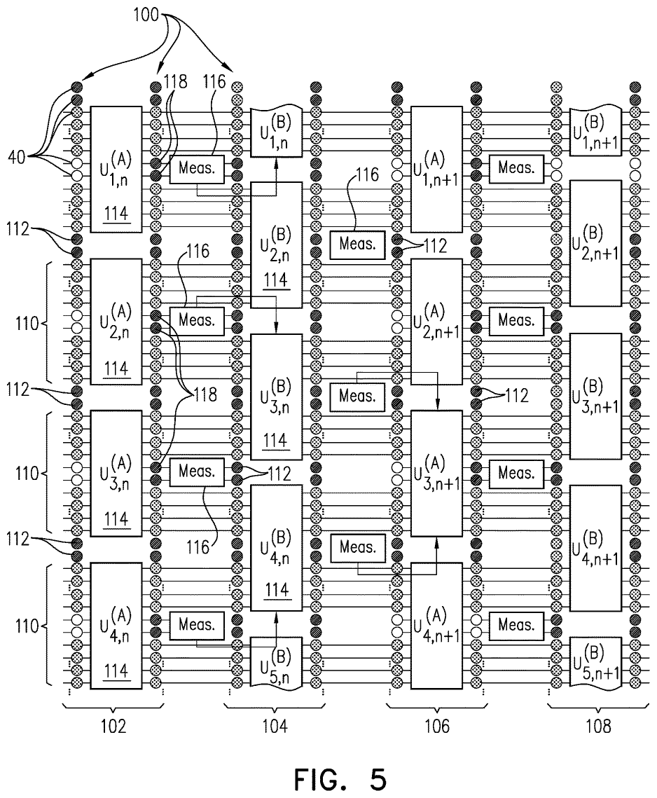

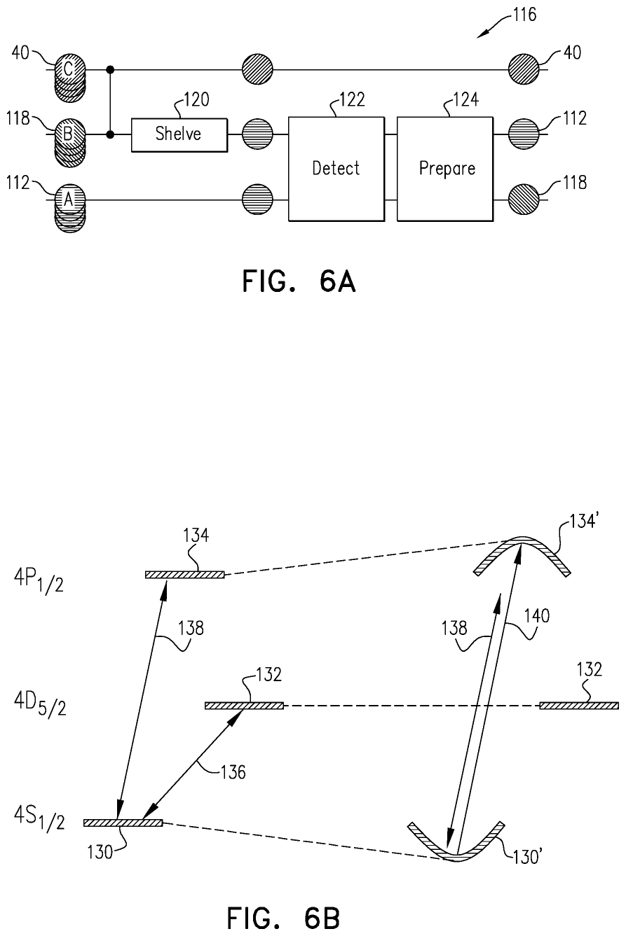

Finally, readout beams 52 are tuned to excite internal transitions of ions 40 for the purpose of reading out states of the gates. Readout beams 52 cause ions 40 to fluoresce, with an intensity depending on the states of the corresponding qubit. The resulting fluorescent emission is measured using optical detector 30, and the result of the computation is received by qubit control and computation processor 32 (FIG. 1). As part of the present scheme, an operational sequence of light pulses can also be used to light shift, shelve, store, and protect data qubits from error due to photon scattering during the measurement sequence. These features are described further hereinbelow with reference to FIGS. 5 and 6A/B.

To operate multi-qubit gates in embodiments of the present invention, various coherent manipulation techniques can be used, such as quadrupole optical transitions used for optical qubits or Raman transitions used for hyperfine or Zeeman qubits. Additionally or alternatively, other methods to encode quantum and manipulate quantum information may be used, such as d-dimensional generalization of qubits (known as qudits) and metastable qubits. In the present example, Raman beams 48 coherently irradiate each group of ions 40 with a set of excitation 10 frequencies ω₀±ωₘ centered around a selected internal instantaneous transition frequency ω₀ of the ions. (Alternatively, any other suitable types of transitions and excitation spectra that are known in the art may be used.) Beams 48 are modulated, for example by a suitable multi-channel acousto-optic modulator (mcAOM), as described below, to coherently include frequency components in multiple sidebands ωₘ of the internal transition frequency ω₀. Alternatively, other forms of modulation, such as an electro-optic modulator (EOM) or a Mach-Zender modulator (MZM), may be used. For example, beams 48 output by a laser operating at around 400 nm may be modulated by the mcAOM to drive the ions, in a Raman transition, with frequencies on sidebands of the S_{1/2} Zeeman split transition of the calcium ion. The internal qubit transition frequency, ω₀, is determined by an externally applied magnetic field B.

Raman beams 48 individually irradiate at least some of ions 40 with the selected frequency components at locally optimal spectra for a gate time T to drive each of the multi-qubit gates from the initial state of the qubit to a target state and thus to complete the quantum computations in each step. In one embodiment of the present invention, individual modulation of Raman beams 48 makes it possible to drive each ion 40 with its own spectra, which typically differs from the spectra applied to the other ions. Other embodiments can also use global Raman beams or semi-global Raman beams (within each segment) or can make use of similar spectra per segment to operate the needed entangling gates within each register segment, or global beams can be used in local operations by individually operated light shift.

After completion of a computational cycle, readout beams 52 may be directed toward ions 40 to read the states of the computational segments, i.e., of the multi-qubit registers defined by tweezer beams 50. Readout beams 52 are tuned to an absorption line of one of the states of the ions in the register. As mentioned above, absorption of the laser radiation by the ions in the appropriate state leads to fluorescence, which is measured by optical detector 30 (FIG. 1). Detector 30 measures the intensity of the fluorescent emissions and thus detects the final state of the qubits and accordingly the final state of the operation. Alternatively, other detection methods that are known in the art may be used to read out the states of the gates.

Processor 32 typically comprises a general-purpose computer, with suitable interfaces to the other components of system 20. Processor 32 is driven by software to carry out the functions and computations that are described herein. The software may be stored on tangible, non-transitory computer-readable media, such as optical, magnetic, or electronic storage media.

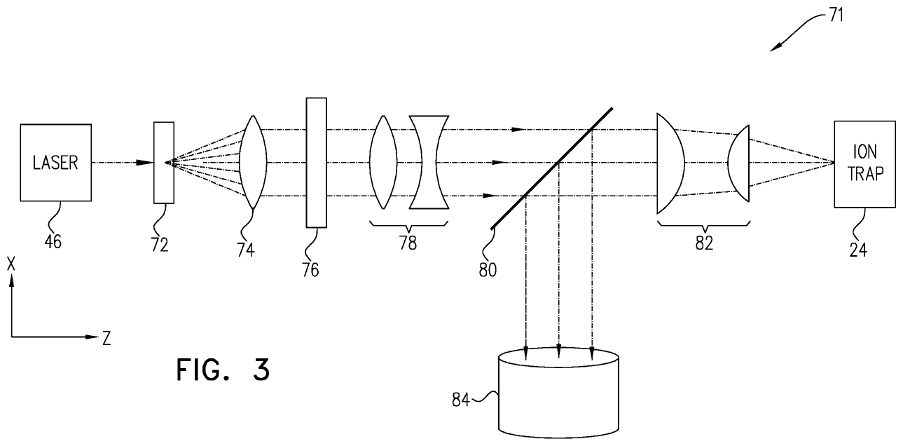

FIG. 3 is a schematic side view of a multi-beam optical trapping and excitation subsystem 71 used in system 20 (FIG. 1), in accordance with an embodiment of the invention. Subsystem 71 forms and conveys beams 48 and 50 (FIG. 2), and possibly also beams 52, from excitation source 46 to ion trap 24. Further details of subsystem 71 are described in the above-mentioned U.S. Provisional Patent Application 63/595,349.

Optical subsystem 71 comprises a splitter 72, which splits coherent radiation output by one or more lasers in excitation source 46 into multiple beams. Splitter 72 may comprise, for example, a diffractive optical element (DOE), a spatial light modulator (SLM), or a multi-channel deflector, such as an acousto-optic deflector (AOD) or micromirror array, or multiple single-channel deflectors. Splitter 72 divides the coherent radiation into multiple beams at different frequencies, angles, amplitudes, and phases. Depending on the type of splitter, the beams may have equal (or roughly equal) intensities, or they may have substantially different intensities, depending on whether they are to serve as Raman beams or tweezer beams during a given time interval.

Following splitter 72, a lens 74 directs the array of beams onto a multi-channel acousto-optic modulator (mcAOM) 76, which modulates the amplitude, frequency, and phase of each of the beams. Specifically, mcAOM 76 applies different, respective frequency and phase shifts to different beams so as to drive respective Raman transitions of the ions on which the beams are incident. Lens 74 may advantageously be configured as a Fourier transform lens, with splitter 72 at its front focal plane and mcAOM 76 at its rear focal plane. Lens 74 thus creates a spatial Fourier transform of the beams, in which the angle of deflection of each beam output by splitter 72 is converted to a transverse location on mcAOM 76 in an array of equally or non-equally spaced, collimated beams.

In the embodiment shown in FIG. 3, the same laser in excitation source 46 generates both the Raman beams and the tweezer beams, and mcAOM 76 modulates the amplitudes of both the Raman beams and the tweezer beams. Alternatively, in other embodiments, different lasers may be used to generate the Raman and tweezer beams. When splitter 72 comprises a DOE or multichannel deflector, the beams that are split out by the splitter may all have high intensities, sufficient to serve as tweezer beams. In this case, mcAOM 76 is controlled to apply substantial attenuation, by a factor of ten or even one hundred or more, to the high-intensity beams from splitter 72 that are to serve as Raman beams. Alternatively, when splitter 72 comprises a multichannel acousto-optic deflector (AOD), controller 32 (FIG. 1) may generate drive signals to adjust the respective intensities of the individual beams output by the AOD. This approach enables rapid switching between different configurations of tweezer and Raman beams. In other embodiments, in which splitter 72 comprises an SLM, the SLM may be driven to modulate the intensities of the beams, so that the beams that are intended to serve as tweezer beams in each computing cycle have higher intensity than the beams intended to serve as Raman beams.

In some embodiments, splitter 72 comprises a fast actuator, such as a rotating mirror or AOD, which switches tweezer beams 50 rapidly between computational steps carried out by array 40. This rapid switching enables the computational segments of array 40 to be reconfigured rapidly from step to step, for efficient execution of a sequence of quantum operations with high fidelity. The reconfiguration of the computational segments in this case can be completed in less than 10 ms. By appropriate design of the system, the reconfiguration time can be reduced to less than 1 ms, less than 100 μs, or less than 10 μs, or possibly even less than 1 μs.

Following mcAOM 76, a telescope 78 directs the modulated beams toward ion trap 24. Telescope 78 also enables adjustment of the beam spacing to match precisely the spacing between ions 40 in the trap. Additionally or alternatively, the drive signals applied to mcAOM 76 or to an AOD may be adjusted to compensate for deviations in the positions, shapes, and focus of beams 62 on the respective ions 40. Following telescope 78, the beams pass through a dichroic beamsplitter 80, for example, and are then focused into ion trap 24 by objective optics 82. Objective optics 82 reduce the spot sizes of beams 62 that are incident on ions 40 to near the diffraction limit, i.e., approximately 1 μm or less, and reduce the spacing between the beams to the separation between ions 40 along axis 38, typically a few microns.

To read out interim and final states of registers 68, excitation source 46 and adjustable readout beams 52 are directed toward the qubits of interest in the registers. Alternatively, the readout beams may be introduced through a different optical channel. Absorption of photons in the readout beams causes ions 40 to emit fluorescent radiation that is indicative of respective states of the quantum gates. Objective optics 82 collect the fluorescent radiation that is emitted by ions 40 in the ion trap 24 and direct the emitted radiation toward dichroic beamsplitter 80, which reflects the emitted radiation onto a detector array 84. Detector array 84 measures the resulting fluorescent emission intensity and reads out the result to controller 32.

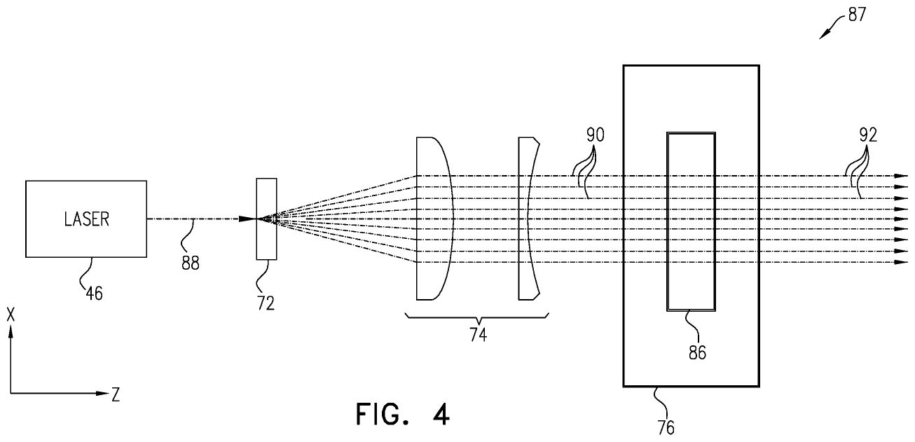

FIG. 4 is a schematic detail view of a multi-beam generation and modulation module 87 in optical subsystem 71, in accordance with an embodiment of the invention. Excitation source 46 outputs a source beam 88, which is then divided into multiple input beams 90 by splitter 72. Fourier transform lens 74 directs beams 90 into an acousto-optic crystal 86 in mcAOM 76. As input beams 90 pass through acousto-optic crystal 86, they are diffracted by acoustic waves in the crystal, resulting in a change in the direction of the diffracted beams. These diffracted beams become an array of output beams 92. This diffraction process modulates output beams 92 so that each beam has its own intensity, frequency, and phase.

### Computational Architecture Including Mid-Circuit Measurements

FIG. 5 is a block diagram that schematically illustrates a sequence of quantum computing steps 102, 104, 106, 108, . . . , performed using an array 100 of trapped ions 40, in accordance with an embodiment of the invention. The state of array 100 is shown by a corresponding column of ions 40 before and after each step. The pictured example shows a part of array 100 that includes about fifty ions, but the principles of this embodiment may be extended in a straightforward way to much larger arrays.

Array 100 is segmented into computational segments 110 by dynamically applying optical trapping potentials to barrier ions 112. In the pictured example, computational segments are separated by pairs of adjacent barrier ions 112. Alternatively, segments may be separated by a single barrier ion or by three or more barrier ions. In the present example, each segment 100 contains ten ions 40. Alternatively, the computational segments may comprise more than ten ions or even more than twenty ions. Furthermore, although all the computational segments 110 in FIG. 5 are shown as having equal sizes, in alternative embodiments the sizes of the segments may be different, depending on computational requirements, and may vary from one computing step to the next.

Raman beams 48 (FIG. 2) apply excitation fields to ions 40 in each computational segment 110 to carry out respective quantum operations 114 in parallel in each successive computing step 102, 104, 106, 108, . . . . Quantum operations 114 typically comprise multi-qubit gate operations, as well as single-qubit gate operations, in some or all of segments 110. For example, the multi-qubit gates may comprise four or more ions 40. In alternative embodiments with larger computational segments (not shown in the figures), the multi-qubit gates may comprise even larger numbers of ions, for example gates comprising twelve ions or more.

Following each computational step 102, 104, 106, . . . , segments 110 in array 100 are reconfigured by selecting a different set of barrier ions 112. (In the pictured embodiment, each step also includes a mid-circuit measurement, as explained below; alternatively, however, the mid-circuit measurements may be omitted.) For the purpose of reconfiguration, tweezer beams 50 (FIG. 2) are switched onto the new barrier ions 112 that are to be used in the next computational step and then switched off the barrier ions 112 that were confined in the previous computational step. In the pictured example, array 100 is switched in this manner in alternation between two configurations, labeled “A” and “B.” In configuration A, quantum operations

$${U}_{j , k}^{( A )}$$

are applied to the computational segments, followed by quantum operations

$${U}_{j , k}^{( B )}$$

in the subsequent configuration B, and then by quantum operations

$${U}_{j , k + 1}^{( A )}$$

in configuration A, and so forth. This process continues until all the steps of the quantum computation have been completed, at which point readout beams 52 (FIG. 2) may be activated to measure the states of ions 40 and thus read out the results of the computation.

Alternatively, other segmentation schemes can be used, without the regular alternation shown in FIG. 5, and possibly including segments of different sizes and/or confining some or all of the same barrier ions over two or more successive computational steps. The system configuration that is shown in FIGS. 1-4 and described above makes it possible to implement substantially any desired computational configuration of barrier ions and computational segments within array 100 and to change the configuration dynamically and rapidly from one computational step to the next.

The coherence time of ions 40 that participate in each computational step is long enough so that at least some coherence is retained from computational segments 110 in configuration A to the new computational segments 110 in configuration B, and similarly from configuration B to configuration A in the subsequent steps. The quantum operations in each subsequent computational step in the sequence thus use some of this retained coherence. In this manner, the ions in the new computational segments at each computational step 104, 106, 108, . . . , can be entangled with some or all of the ions from the previous computational segments. The number of computational steps s that are required to entangle all (or at least a substantial fraction) the ions in array 100 in this manner depends on the sizes and degree of overlap of computational segments 110 from step to step. Typically, s is substantially smaller than the number of ions N. In the configuration shown in FIG. 5, for example, without using of mid-circuit measurements, the number of steps s that are needed to entangle at least 70% of ions 40 in computational segments 110 is less than 0.2*N.

The computational configuration that is shown in FIG. 5 also facilitates mid-circuit measurements 116 between successive computational steps 102 and 104, and then between steps 104 and 106, and so forth. The results of mid-circuit measurements 116 are used in providing classical feedback for use in defining quantum operations 114 in subsequent computational steps, for example for purposes of quantum error correction. In the pictured example, mid-circuit measurements 116 are applied to intermediate ions 118, which are then optically confined to serve as barrier ions 112 in the next computational step. The process of performing these mid-circuit measurements and then reconfiguring array 100 into new computational segments 110 by reading out and then cooling intermediate ions 118 can typically be completed within a duration shorter than 20 ms, and possible shorter than 10 ms.

Reference is now made to FIGS. 6A and 6B, which schematically illustrates a method for mid-circuit measurement within a sequence of quantum computing steps, in accordance with an embodiment of the invention. This method may be applied in array 100 in implementing mid-circuit measurements 116, as described above. FIG. 6A is a flow diagram showing steps of the measurement process, while FIG. 6B is an atomic level diagram that schematically shows details of energy levels of ⁴⁰Ca⁺ ions that are used in the mid-circuit measurement of FIG. 6A. These particular energy levels are shown here by way of example, and the principles of the method of FIG. 6A may similarly be applied using other suitable ions and other sets of energy levels.

The method of FIG. 6A uses three types of ions, taken from FIG. 5: computational ions 40 (labeled C); intermediate ions 118 (labeled B); and current barrier ions 112 (labeled A). As a result of the preceding quantum operation 114, for example in step 102, data is encoded on computational ion C, as well as on intermediate ion B. One of the qubit states of ion B is “shelved” to a non-fluorescing state using local control, in a shelving step 120. Next an intermediate optical segmentation configuration is applied, by applying optical confinement fields to both ions A and B and thus separating their motion from the computational qubits 40. The state of the barrier ions is measured, in a detection step 122, and then reset, in a preparation step 124. Lastly, in preparation for the next computational step 104, the optical segmentation configuration is switched, so that ion B becomes a barrier ion and ion A is freed to serve as an intermediate or computational ion.

FIG. 6B shows relevant atomic levels (not to scale) for implementing the method of FIG. 6A using an array of ⁴⁰Ca⁺ ions, including the 4S_{1/2} ground state manifold 130, the metastable 4D_{5/2} manifold 132, and the short-lived 4P_{1/2} manifold 134. Manifolds 130 and 134 at the left side of FIG. 6B represent the interaction between the S and P states without optical confinement (as used in computational operations), whereas manifolds 130′ and 134′ represent the states of optically confined barrier ions. A shelving field 136 at 729 nm couples the S and D levels, while a Raman field 138 at 400 nm generates Raman transitions and a light shift between the qubit states in the S_{1/2} manifold 130 via off-resonant coupling to the 4P_{1/2} manifold 134. An additional field 140 at 397 nm is used for cooling, state preparation and detection.

Raman field 138 is used for local control, acting independently on all computational ions 40, to generate single-qubit rotations and multi-qubit programmable gates. Raman field 138 is also used, however, to localize global control fields using light-shifts. In particular, shelving step 120 can be carried out by applying fields 136 and 138 together, which causes one of the qubit states of ion 118 (ion B in FIG. 6A) to be shelved to manifold 132.

After shelving ions 118, the segmentation configuration of array 100 is changed to an intermediate setting in which all barrier ions 112 and 118 are illuminated. The purpose of optically confining the ion is to prepare it for being measured, by separating its motion from the motion of the computational qubits, and to light-shift its S↔P transition. State detection at step 122 is performed using the light-shifted field 140 at 397 nm field, followed by qubit reset and preparation, to cool the ions, using a combination of fields 140 and 138 at 397 nm and 400 nm respectively, at step 124.

After preparation step 124, the segmentation configuration of array 100 is changed, exchanging the roles of computational and barrier ions. The cooled ions in turn cool down the bulk vibrational modes of the array via sympathetic cooling.

### Optical Trapping Requirements

As noted earlier, segmentation of array 100 of ions 40 (FIG. 5) preserves the stability of the ion crystal and enables programmable multi-qubit quantum gates to act simultaneously and independently within the different computational segments. The confinement of barrier ions 112 that are irradiated by tweezer beams 50 (FIG. 2) can be expressed in terms of an optical trapping potential, which induces an optical trapping frequency:

$${ω}_{otp} = \sqrt{\frac{2 Re [ α ( λ ) ]}{m}} \vert E \vert$$

In this expression, α(λ) is the wavelength-dependent polarizability of the barrier ion, m is its mass, and E is the electric field strength of the optical trapping beam.

The impact of the optical trapping potential can be compared to the basic trapping frequency of ion trap 24, which is the inter-ion characteristic frequency associated with the Coulomb interaction between adjacent ions:

$$v = \sqrt{\frac{{e}^{2}}{4 {πϵ}_{0} {md}^{3}}} ,$$

wherein e is the electron charge, ϵ₀ is the vacuum permittivity, and d is the inter-ion distance in the array. In a linear array of ions, such as the arrays shown in the preceding figures, V represents the Coulomb frequency scale of the array. Application of excitation fields to ions 40, for example by Raman beams 48 (FIG. 2), excites the motional modes of array 100, with vibrational frequencies of the motional modes centered around basic trapping frequencies ωₜᵣₐₚ, which may include both radial and axial modes, depending on the frequencies of the excitation fields.

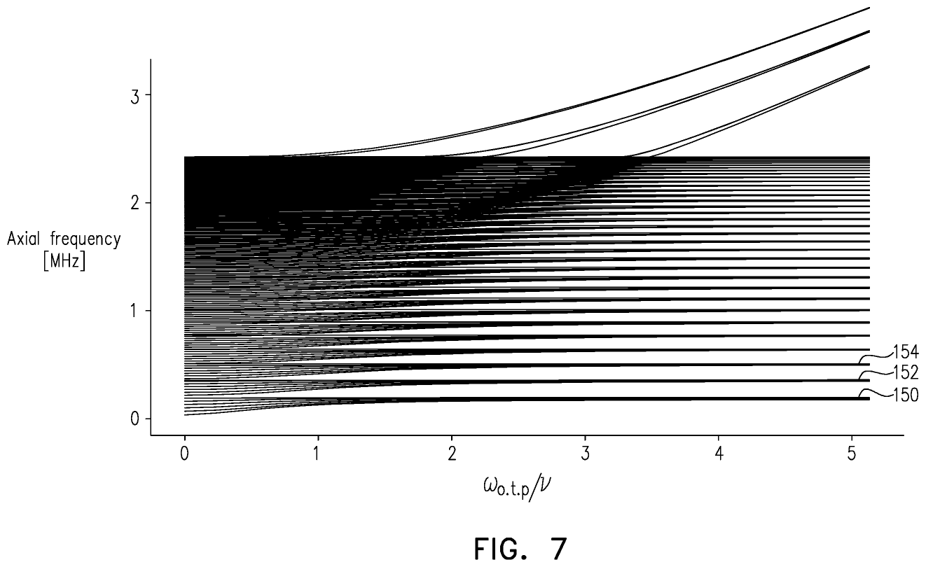

FIG. 7 is a plot that schematically shows changes in axial mode frequency bands 150, 152, 154, . . . , of an array of trapped ions as a function of the optical trapping potential that is applied in segmenting the array, in accordance with an embodiment of the invention. The lowest frequency band 150 corresponds to the center-of-mass band. The relative strength of the optical trapping potential is expressed in terms of the ratio ωₒₜₚ/V. The frequencies in this figure are calculated for an array of N=231 ions, which is segmented into six computational segments of thirty-five ions each, separated by three barrier ions between neighboring segments.

As shown in this figure, for weak optical trapping fields, the computational segments are vibrationally coupled together, giving rise to a diffuse band structure. As ωₒₜₚ/ν increases, beyond a level of about 1.5, the structure of frequency bands 150, 152, 154, . . . , becomes distinct, making it possible to address different vibrational modes in different computational segments. Above this level of the optical trapping potential, the optical confinement of the barrier ions groups the motional frequencies of the ions into bands 150, 152, 154, . . . , such that the bandwidth of each band is smaller than the difference between the mean frequencies of adjacent bands.

For ωₒₜₚ/ν>1.8, the bandwidths of bands 150, 152, 154, . . . , are less than 20% of the difference between the mean frequencies, with the bandwidths decreasing to 10% and even less than 5% of the difference between the mean frequencies as the optical trapping potential increases. For ωₒₜₚ=2ν, the narrow band structure approximates that of an independent array of thirty-five ions, meaning that the motional modes in different computational segments are decoupled from one another (although a small amount of crosstalk remains, as discussed further hereinbelow). This decoupling of the motional modes makes it possible to perform the sorts of parallel multi-qubit operations that are described above, using these decoupled motional modes. When neighboring computational segments are separated by a group of two or more barrier ions, decoupling of the computational segments is reinforced. In this case, sufficient decoupling can be achieved by applying tweezer beams with an intensity sufficient to trap the barrier ions optically with respective optical trapping frequencies ωₒₜₚ, such that the sum of the respective trapping frequencies is greater than 2ν.

Another benefit of the strong optical trapping potentials that are applied in confining the barrier ions in the present embodiments is in reducing the rate of heating of the ions in the array. Decoupling of the vibrational modes of the neighboring computational segments at high ωₒₜₚ, as illustrated in FIG. 7, means that the rate of heating of the ions is determined primarily by the respective sizes of the computational segments, rather than by the total number of ions in the array.

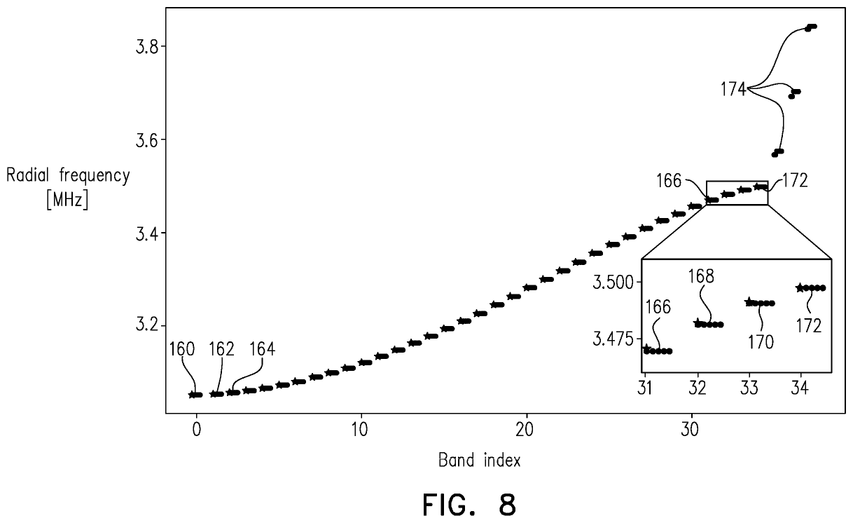

FIG. 8 is a plot that schematically shows frequencies of radial modes 160, 162, 164, . . . , 166, 168, 170, 172 in a segmented array of trapped ions, in accordance with an embodiment of the invention. The radial mode frequencies were calculated for the same segmented array of N=231 ions, whose axial spectrum was shown in FIG. 7, assuming ωₒₜₚ=2.1ν. There are thirty-five radial bands, each containing six modes, corresponding to the thirty-five ions in each computational segment, along with additional high-frequency modes 174 associated with the barrier ions.

As shown in the inset in FIG. 8, the modes are well separated in frequency, with respective bandwidths BW that are much smaller than the band separation Δω. The crosstalk in the entanglement operations between neighboring computational segments is given approximately by ε=BW/2Δω and is estimated on this basis in the present example to be about 2.5%.

### Mitigation of Residual Crosstalk

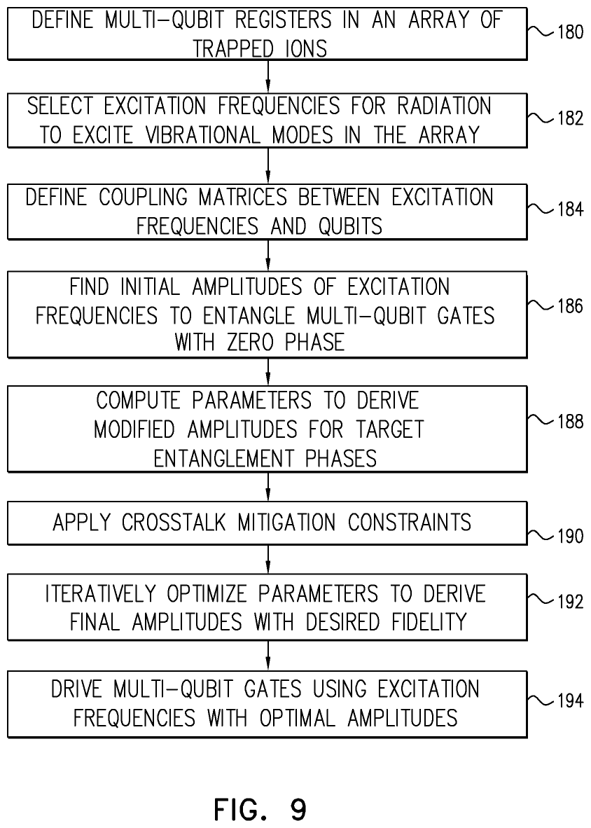

FIG. 9 is a flow chart that schematically illustrates a method for selecting parameters to drive multi-qubit gates in a segmented array of trapped ions, in accordance with an embodiment of the invention. This method is based on the techniques for computing the frequencies and complex amplitudes of excitation fields for multi-qubit gates that are described in U.S. Provisional Patent Application 63/506,142, filed Jun. 5, 2023, whose disclosure is incorporated herein by reference. The present method extends these techniques to compensate for the crosstalk between computational segments in a segmented array, such as array 100 (FIG. 5). This method suppresses the effect of the residual crosstalk that remains notwithstanding the confinement of the barriers and thus enhances the fidelity of quantum operations performed using the array.

The method of FIG. 9 is initiated by defining a set of multi-qubit registers in an array of trapped ions, in a register definition step 180. For example, the registers may correspond to computational segments 110, which are defined by barrier ions 112 in array 100 in each computing step 102, 104, 106, 108, . . . , as shown in FIG. 5. A number M>2 of excitation frequency pairs is selected to excite vibrational modes in segments 110, in a frequency selection step 182. The frequency pairs have respective frequencies ω₀±ωₘ and respective amplitudes rₘ defined by an amplitude vector r=<r₁, r₂, . . . , r_{M}>. (Here ω₀ is the instantaneous internal transition frequency of the qubits from a ground state to an excited state.) Although it is possible to apply the same vector of amplitudes to all the qubits, embodiments of the present invention relate to the more general case in which a different, respective amplitude vector rₙ is applied to each qubit independently, so that the complete set of amplitudes can be represented by a matrix r of dimensions N×M, wherein N is the number of qubits in each segment.

To compute the respective excitation spectra that are to be applied to ions 40, a set of N(N—1)/2 coupling matrices A_{n,m} is defined, in a matrix definition step 184. The matrices, having dimensions M×M, are defined to represent the interactions between the excitation frequency pairs and the qubits n and m in each segment of the array, based on the normal modes of vibration of the qubits. Specifically,

$${A}_{n , m} = {\sum }_{j = 1}^{N} {O}_{j}^{n} {O}_{j}^{m} {A}_{j} ,$$

with O an N×N matrix such that

$${O}_{j}^{n}$$

is the participation of the nth ion in the jth motional mode. Aⱼ represents the interactions between the excitation frequency pairs and the jth mode of motion. The A_{n,m} matrices are constructed as linear combinations of the Aⱼ matrices.

The respective target entanglement phase vector for each computational segment is defined as φ=<φ_{1,2}, φ_{1,3}, . . . , φ_{1,N}, φ_{2,3}, . . . , φ_{N-1,N}>. This target entanglement is achieved by applying amplitude vectors r₁, . . . , r_{N} that satisfy

$${r}_{n}^{T} {A}_{n , m} {r}_{m} = {φ}_{n , m}$$

for all 1≤n≤m≤N, as well as addition linear constraints of the form Lr_n=0 for all n=1, . . . , N, for the purpose of generating high-fidelity operation and robustness against various sources of error and noise. The problem of achieving the target entanglement can be represented by constructing the vector,

$${R}^{T} = ( {r}_{1}^{T} , {r}_{2}^{T} , … , {r}_{N}^{T} ) ,$$

i.e., a vector made of all the vectors of amplitude driving the respective ions. We also define Ã_{n,m} as a NM×NM matrix made of N×N blocks of size M×M, which are all zero except for the (n, m) and (m, n) blocks, which take the value

$$\frac{1}{2} {A}_{n , m} .$$

With this formulation, the problem of finding the excitation spectra for the qubits in a given computational segment takes the form, R^{T}Ã_{n,m}R=φ_{n,m}, for all 1<n<m<N. Direct solution of this equation, however, is a hard problem, as explained in the above-mentioned U.S. Provisional Patent Application 63/506,142.

To enable fast, efficient computation of a solution, initial non-trivial excitation spectra are computed for each computational segment so as to entangle each of the multi-qubit gates with zero entanglement phase, in a zero-phase step 186. This step finds an initial non-trivial amplitude vector R₀ satisfying the constraints

$${R}_{0}^{T} {A}_{n , m} {R}_{0} = 0$$

for all 1<n<m<N, i.e., resulting in the entanglement phase φ_{n,m}=0 for all qubit pairs. Solving this zero-phase instance involves a number of quadratic constraints that is only on the order of N. The reduction from the order of N² quadratic constraints to N quadratic constraints can be realized by solving the zero-phase instance

$${r}_{0}^{T} {A}_{j} {r}_{0} = 0$$

for all j=1, . . . , N and setting

$${R}_{0}^{T} = ( {r}_{0}^{T} , {r}_{0}^{T} , … , {r}_{0}^{T} ) .$$

Once this initial solution has been found, modified spectral parameters are computed for each computational segment to achieve the desired target entanglement phases, at a spectral modification step 188. In this step, for example, parameters λ and D can be computed by a linear solution process to find a nearby amplitude vector R=λR₀+D that satisfies R^{T} A_{n,m}R=φ_{n,m} for all 1<n<m<N. (The vector R is “nearby” in the multidimensional solution space defined by the N·M vector elements of R in the sense that the magnitude of the vector D is small compared to that of λR₀.)

The solution space will next be optimized, for example in a gradient descent process, to find an optimized target vector Rₒₚₜ for each computational segment that locally satisfies the constraint argmin|Rₒₚₜ| such that Rₒₚₜ^{T} Ã_{n,m}Rₒₚₜ=φ_{n,m} for all 1<n<m<N. The solution Rₒₚₜ represents a set of spectral components in respective sidebands of the internal transition frequency ω₀ and indicates the respective complex amplitudes of the spectral components that are to be applied to each of the qubits. Simultaneous application of these spectral components to the qubits in the array excites selected normal modes of vibration and causes the multi-qubit gate to switch from an initial state to a target state having the target entanglement phase.

In addition to the constraints among the qubits within each computational segment in this optimization process, crosstalk mitigation constraints are computed for application in the optimization process to compensate for the estimated residual crosstalk between the segments, at a crosstalk mitigation step 190. For this purpose, the residual crosstalk between neighboring computational segments is estimated. This residual crosstalk was estimated above to be about 2.5%, based on the bandwidths of the vibrational bands, for example as shown in FIG. 7. A more accurate estimate of the residual crosstalk can be derived by constructing matrices, similar to the coupling matrices A_{n,m} that were described above, representing the coupling between the ions in neighboring computational segments. The level of residual crosstalk can then be computed as the ratio between the amplitude of the coupling between ions in different segments to the amplitude of the coupling between the ions within a single segment. The results are similar to the simpler bandwidth-based estimate.

Using the estimated residual crosstalk, the vector R of amplitudes for each computational segment is iteratively optimized to derive a final, optimal vector Rₒₚₜ that compensates for the effects of crosstalk to achieve a desired fidelity target, at crosstalk optimization step 192. The loss of fidelity due to crosstalk (and other factors) can be expressed, following each iteration i, in terms of the deviation of the phases of the qubits in each segment at the end of the gate time relative to the respective target phases: Δφ⁽ⁱ⁾=φ⁽ⁱ⁾−φ^{t}. This deviation is expressed in terms of both the deviations due to interactions between the qubits within each segment and interactions between qubits in neighboring segments, based on the corresponding coupling matrices. Because of the strong influence of the barrier ions in isolating the computational segments from one another, it is typically sufficient in this computation to account only for interactions between each computational segment and its immediate neighbors. Longer-range interactions can be neglected, at least to first order. (Higher orders, including longer-range interactions, can be taken into account if necessary.)

A formal definition of the phase deviations due to residual crosstalk and an algorithm for optimizing the excitation spectra to minimize infidelity in the presence of the residual crosstalk is presented below in an Appendix.

Based on the computed phase deviations, a new set of modified amplitudes R is computed to reduce the phase deviation and thus increase the fidelity of the quantum computations. This process is repeated iteratively, resulting in reducing the infidelity in each iteration, until the desired target is reached, yielding the final, optimal vector Rₒₚₜ.

Once an optimal solution has been found, the N ions in each of computational segments 110 are driven at the respective spectra of M frequencies

$${\{ {ω}_{0} \pm {ω}_{m} \}}_{m = 1}^{M} ,$$

with the respective amplitudes defined by Rₒₚₜ for each ion, at a gate driving step 194. Thus, multiple quantum computations are performed in parallel over the computational segments of array 100. After completion of these computations, the computational segments are reconfigured, and the process described above is repeated for the next computing step in the sequence. As noted earlier, from each computing step to the next the ions retain at least some coherence, which can be transferred between segments in the register.

The gate time of each of the multi-qubit gates defined in array 100 is governed by the minimum spacing Δf between the respective vibrational frequencies of the group of normal modes that are excited by the applied radiation. In the adiabatic limit, with gate time T>>1/Δf, the coupling matrices Aₙ become diagonal, and an amplitude vector r that will satisfy the constraints can be found easily; but in this case the long gate time makes the multi-qubit gates impractical for actual quantum computations. Therefore, in some embodiments of the present invention, the coupling matrices are chosen to support a faster gate time, for example T<50/Δf or even T<10/Δf. The coupling matrices in such cases are generally dense, but the methods described above can be applied to find optimal amplitude vectors r that will enable the desired fast gate time. Constraints on the maximum infidelity and resilience to errors, noise, and residual crosstalk can also be added to the solution process, to ensure that the resulting amplitude vectors will drive multiple multi-qubit gates in parallel with high fidelity and robustness.

The respective vibrational frequencies of the normal modes that are used in the multi-qubit gates extend over a certain frequency range, from a minimum normal-mode frequency to a maximum normal-mode frequency. To achieve fast switching (with T<50/Δf), the bandwidth of the radiation that is used in driving the gate is at least 10% of this frequency range and may cover the entire frequency range.

FIG. 10 is a plot that schematically shows the infidelity of a segmented array of trapped ions, such as array 100 (FIG. 5), as a function of an optical trapping potential that is applied to barrier ions 112 in segmenting the array, in accordance with an embodiment of the invention. The infidelity is expressed in terms of the error per computational segment 110, based on the deviation of the phases of the qubits in each segment at the end of the gate time relative to the respective target phases, as defined above. An upper curve 200 shows the residual crosstalk prior to optimization of the excitation spectra, while a lower curve 202 shows the reduced crosstalk achieved by compensating for the residual crosstalk using the method shown in FIG. 9. Both curves 200 and 202 drop sharply when ωₒₜₚ>1.8ν.

As illustrated by the difference between curves 200 and 202 in FIG. 10, the techniques of spectral optimization that are described above can be used to compensate for and reduce the error due to residual crosstalk by two or more orders of magnitude. As a result, the level of infidelity of the quantum operations carried out using the array can be reduced to less than 0.1. With increasing computational effort applied in the method described below, the level of infidelity can be reduced to less than 0.01, or less than 0.001, or even less than 0.0001.

### Two- and Three-Dimensional Trapped Ion Arrays

As noted earlier, although the examples described above relate to linear arrays of trapped ions 40, the principles of the present invention may similarly be applied, mutatis mutandis, to two- and three-dimensional trapped ion arrays. Ion traps that are capable of creating two- or three-dimensional ion arrays are known in the art. In such arrays, layers of barrier ions can be created by confining selected ions using optical trapping potentials applied by suitable laser beams. These layers of barrier ions define two- and three-dimensional computational segments, which can then be driven by excitation fields to carry out complex quantum operations. After each operation, the array can be reconfigured by selecting and confining a new set of barrier ions, as in the case of the linear arrays described above.

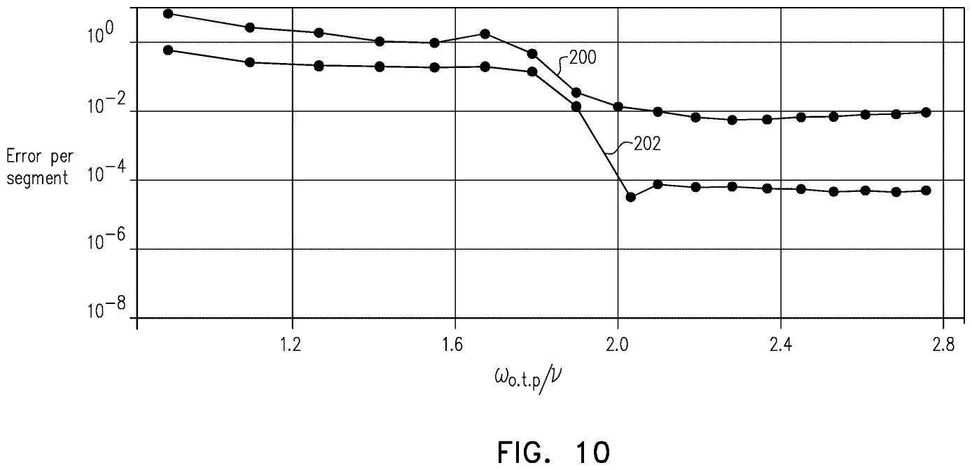

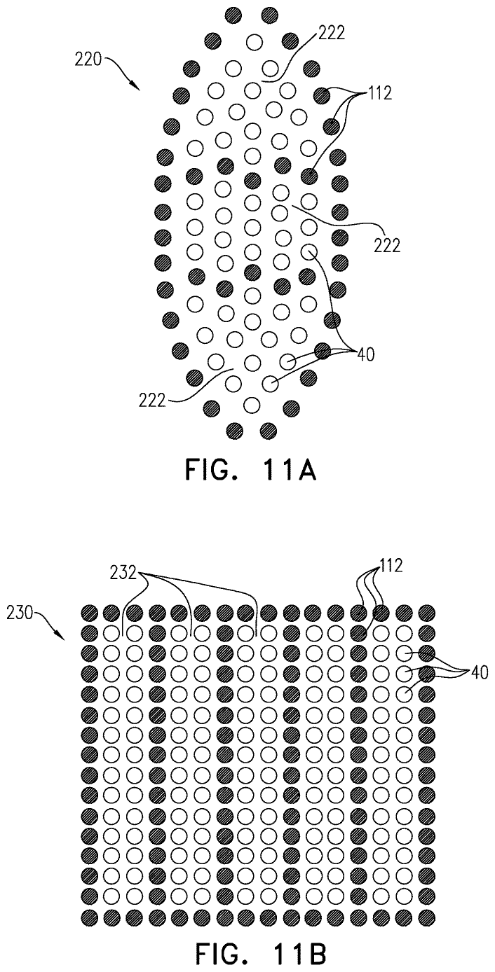

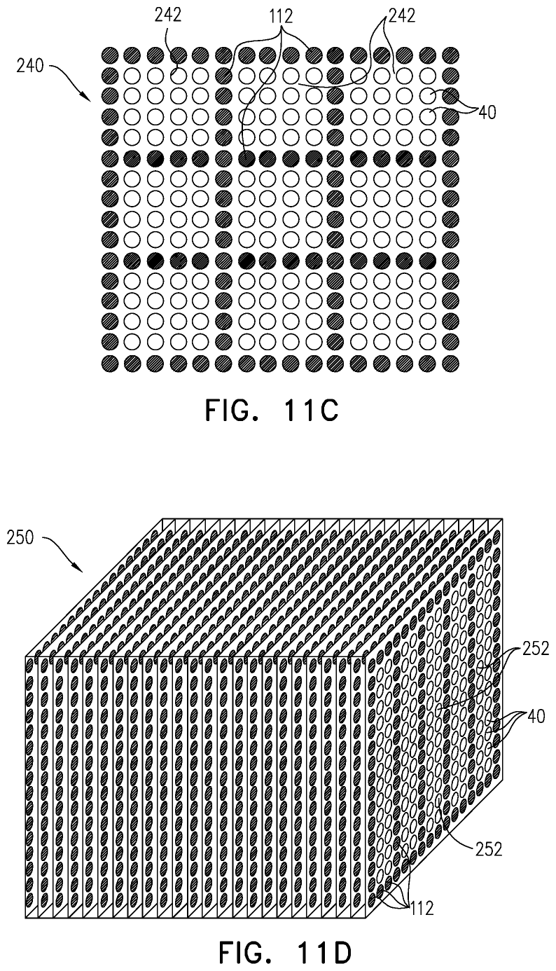

FIG. 11A is a schematic frontal view of a partitioned two-dimensional array 220 of trapped ions 40, in accordance with an embodiment of the invention. This array geometry is based on a trapping scheme described by Kiesenhofer et al., in “Controlling Two-Dimensional Coulomb Crystals of More Than 100 Ions in a Monolithic Radio-Frequency Trap,” published in PRX QUANTUM 4, 020317 (2023). Barrier ions 112 are optically confined around the periphery of array 220 and along transverse segmentation boundaries, thus partitioning the array into two-dimensional computational segments 222.

FIG. 11B is a schematic frontal view of a partitioned two-dimensional array 230 of trapped ions 40, in accordance with another embodiment of the invention. Array 230 is rectangular in form, and rows of barrier ions 112 partition array 230 into multiple parallel two-dimensional computational segments 232.

FIG. 11C is a schematic frontal view of a partitioned two-dimensional array 240 of trapped ions 40, in accordance with yet another embodiment of the invention. In this embodiment, too, array 240 is rectangular and is partitioned into a matrix of computational segments 242 by rows and columns of barrier ions 112.

FIG. 11D is a schematic frontal view of a partitioned three-dimensional array 250 of trapped ions, in accordance with an alternative embodiment of the invention. Optical trapping potentials are applied to barrier ions 112 to define computational segments 252 made up of parallel three-dimensional “slices” of ions 40. Alternatively, as in the two-dimensional case, multiple different configurations of the barrier ions can be used to create different, corresponding two- and three-dimensional computational segment topologies.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX—CROSSTALK MITIGATION ALGORITHM

As explained above, in solving for the final, optimal vector Rₒₚₜ, the loss of fidelity due to crosstalk (and other factors) can be expressed, following each iteration i, in terms of the deviation of the phases of the qubits in each segment at the end of the gate time relative to the respective target phases: Δφ⁽ⁱ⁾=φ⁽ⁱ⁾−φ^{t}. The qubit-qubit coupling between ions c (c′) in segments s (s′) can be evaluated in each step i as:

$${φ}_{( s , c ) , ( {s}^{′} , {c}^{′} )}^{( i )} = {( {r}_{s , c}^{( i )} )}^{T} {A}_{( s , c ) , ( {s}^{′} , {c}^{′} )} {r}_{{s}^{′} , {c}^{′}}^{( i )}$$

The deviation from the target phase is given by:

$${Δφ}_{( s , c ) , ( {s}^{′} , {c}^{′} )}^{( i )} = {φ}_{( s , c ) , ( {s}^{′} , {c}^{′} )}^{( i )} - {ϕ}_{( s , c ) , ( {s}^{′} , {c}^{′} )}^{t}$$

In each iteration of the optimization process, the vector of amplitudes is updated by a correction factor:

$${r}_{s , c}^{( i + 1 )} = {r}_{s , c}^{( i )} + {δ}_{s , c}^{( i + 1 )}$$

For adjacent segments s and s+1, the correction factors to compensate for inaccuracies and crosstalk are given by the following equations:

$${( {δ}_{s , c}^{( i + 1 )} )}^{T} {A}_{( s , c ) , ( s , {c}^{′} )} {r}_{s , {c}^{′}}^{( i )} + {( {δ}_{s , {c}^{′}}^{( i + 1 )} )}^{T} {A}_{( s , c ) , ( s , {c}^{′} )} {r}_{s , c}^{( i )} = {Δφ}_{( s , c ) , ( s , {c}^{′} )}^{( i )}$$

$${( {δ}_{s + 1 , c}^{( i + 1 )} )}^{T} {A}_{( s + 1 , c ) , ( s + 1 , {c}^{′} )} {r}_{s + 1 , {c}^{′}}^{( i )} + {( {δ}_{s + 1 , {c}^{′}}^{( i + 1 )} )}^{T} {A}_{( s + 1 , c ) , ( s + 1 , {c}^{′} )} {r}_{s , c}^{( i )} = {Δφ}_{( s + 1 , c ) , ( s + 1 , {c}^{′} )}^{( i )}$$

$${( {δ}_{s , c}^{( i + 1 )} )}^{T} {A}_{( s , c ) , ( s + 1 , {c}^{′} )} {r}_{s + 1 , {c}^{′}}^{( i )} + {( {δ}_{s + 1 , {c}^{′}}^{( i + 1 )} )}^{T} {A}_{( s , c ) , ( s + 1 , {c}^{′} )} {r}_{s , c}^{( i )} = {Δφ}_{( s , c ) , ( s + 1 , {c}^{′} )}^{( i )}$$

$${( {δ}_{s , c}^{( i + 1 )} )}^{T} {A}_{( s , c ) , ( s - 1 , {c}^{′} )} {r}_{s - 1 , {c}^{′}}^{( i )} = {Δφ}_{( s , c ) , ( s - 1 , {c}^{′} )}^{( i )}$$

$${( {δ}_{s + 1 , c}^{( i + 1 )} )}^{T} {A}_{( s + 1 , c ) , ( s + 2 , {c}^{′} )} {r}_{s + 2 , {c}^{′}}^{( i )} = Δ {φ}_{( s + 1 , c ) , ( s + 2 , {c}^{′} )}^{( i )}$$

The first two equations above account for inaccuracies within each segment s or s+1, while the last three equations account for crosstalk between adjacent segments.

The deviation Δφ⁽ⁱ⁾ from the target phrase is optimized by computing

$${δ}_{s , c}^{( i + 1 )}$$

over multiple iterations until the solution converges or until it meets a certain fidelity criterion. For the latter purpose, the infidelity can be evaluated as follows:

$$I = {I}_{s h o r t} + {I}_{l o n g} + {I}_{m o t i o n}$$

$${I}_{s h o r t} = 2 {\sum }_{s = 1}^{S} {\sum }_{c , {c}^{′} = 1}^{C + {B}_{B}} ( {\vert {Δφ}_{( s , c ) , ( s , {c}^{′} )}^{( f )} \vert}^{2} + {\vert {Δφ}_{( s , c ) , ( s + 1 , {c}^{′} )}^{( f )} \vert}^{2} + {\vert Δ {φ}_{( s , c ) , ( s - 1 , {c}^{′} )}^{( f )} \vert}^{2} )$$

$${I}_{l o n g} = 2 {\sum }_{s = 1}^{S} {\sum }_{{s}^{′} \neq s , s \pm 1}^{S} {\sum }_{c , {c}^{′} = 1}^{C + {B}_{B}} {\vert {Δφ}_{( s , c ) , ( {s}^{′} , {c}^{′} )}^{( f )} \vert}^{2}$$

$${I}_{m o t i o n} = {\sum }_{j = 1}^{N} {\sum }_{n = 1}^{N} \vert {α}_{j}^{( n )} \vert$$

In the formula for Iₘₒₜᵢₒₙ,

$${α}_{j}^{( n )}$$

is the displacement of motional mode j of the ion chain due to ion n.

1. A method for quantum computing, comprising:
trapping an array of ions in an ion trap with an inter-ion characteristic frequency
$$v = \sqrt{\frac{{e}^{2}}{4 {πϵ}_{0} {md}^{3}}} ,$$
wherein e is the electron charge, ϵ₀ is the vacuum permittivity, m is the mass of each ion, and d is the inter-ion distance in the array;
defining a quantum computation comprising a sequence of computing steps, each step comprising multiple quantum operations to be performed in parallel;
segmenting the array into first computational segments comprising respective groups of at least ten adjacent ions separated by first barrier ions between the groups, by optically confining the barrier ions by applying optical radiation to a set of the barrier ions between adjacent computational segments with an intensity sufficient to confine the barrier ions optically with respective optical trapping frequencies ωₒₜₚ, such that a sum of the respective optical trapping frequencies over the set is greater than 2ν;
applying excitation fields to the ions in the first computational segments so as to cause the groups of the adjacent ions in the first computational segments to carry out the quantum operations in a first step in the sequence;
after completing the quantum operations in the first step, reconfiguring the array into second computational segments by optically confining second barrier ions, at least some of which are different from the first barrier ions, while retaining at least some coherence from the first computational segments to the second computational segments;
applying the excitation fields to the ions in the second computational segments so as to cause the groups of the adjacent ions in the second computational segments to carry out the quantum operations in a second step in the sequence using at least some of the retained coherence; and
repeating the steps of reconfiguring the array into further computational segments and applying the excitation fields to the further computational segments to complete the quantum computation.

2-3. (canceled)

4. The method according to claim 1, wherein trapping the array of ions comprises forming a two-dimensional array of the ions.

5. (canceled)

6. The method according to claim 1, wherein optically confining the barrier ions comprises applying optical tweezers to the barrier ions using laser beams that are tuned to apply optical attractive forces or repulsive forces to the barrier ions.

7. (canceled)

8. The method according to claim 1, and comprising performing a mid-circuit measurement by sensing a state of one or more of the barrier ions following at least the first step in the sequence,
wherein applying the excitation fields to the ions in the second computational segments comprises using information contained in the sensed state in the mid-circuit measurement in defining the quantum operations to be performed in subsequent steps.

9-13. (canceled)

14. The method according to claim 1, wherein applying the excitation fields comprises directing beams of coherent optical radiation to excite transitions of the ions in the computational segments,
wherein applying the excitation fields comprises setting respective spectra of the beams and pulse times to drive the ions to complete the quantum operations in each step, and
wherein optically confining the barrier ions reduces a crosstalk between neighboring computational segments in the array.

15-18. (canceled)

19. The method according to claim 14, wherein setting the respective spectra and pulse times comprises estimating the crosstalk between the neighboring computational segments in the array, and choosing the respective spectra and pulse times to compensate for the estimated crosstalk,
wherein compensating for the estimated crosstalk decreases an infidelity of the quantum operations to less than 0.01.

20-24. (canceled)

25. The method according to claim 1, wherein optically confining the barrier ions reduces a rate of heating of the ions in the array, wherein the rate of heating is determined primarily by respective sizes of the computational segments, rather than by a number of the ions in the array.

26. (canceled)

27. The method according to claim 1, wherein applying the excitation fields comprises exciting motional modes of the array of ions having respective motional frequencies, and wherein optically confining the barrier ions groups the motional frequencies into bands having respective mean frequencies and bandwidths, such that the bandwidth of each band is no more than 10% of a difference between the mean frequencies of adjacent bands.

28-33. (canceled)

34. The method according to claim 1, wherein at least some of the quantum operations comprise multi-qubit gate operations executed over gates that comprise four or more of the ions.

35. (canceled)

36. The method according to claim 1, wherein reconfiguring the array into the second computational segments while retaining the at least some coherence comprises entangling the ions in the second computational segments with the ions in the first computational segments,
wherein the array comprises n ions, and wherein entangling the ions in the second computational segments comprises controllably entangling at least 70% of the ions in the computational segments in the array, without using mid-circuit measurements, over number s of the reconfiguring steps such that s<0.2*n.

37-38. (canceled)

39. The method according to claim 1, wherein reconfiguring the array into the second computational segments is completed in a duration shorter than 1 ms.

40-52. (canceled)

53. The method according to claim 1, wherein segmenting the array gives rise to motional modes within the computational segments having respective vibrational frequencies grouped in frequency bands, with a minimal spacing Δf between the frequency bands, and wherein applying the excitation fields drives the ions to the target entanglement phases within a time that is less than 50/Δf.

54-100. (canceled)

101. A system for quantum computing, comprising:
an ion trap, which is configured to hold an array of ions in respective positions along an array axis with an inter-ion characteristic frequency
$$v = \sqrt{\frac{{e}^{2}}{4 {πϵ}_{0} {md}^{3}}} ,$$
wherein e is the electron charge, ϵ₀ is the vacuum permittivity, m is the mass of each ion, and d is the inter-ion distance in the array;
a radiation source, configured to apply optical fields to segment the array into multiple computational segments comprising respective groups of at least ten adjacent ions separated by barrier ions between the groups, by optically confining the barrier ions by applying optical radiation to a set of the barrier ions between adjacent computational segments with an intensity sufficient to confine the barrier ions optically with respective optical trapping frequencies ωₒₜₚ, such that a sum of the respective optical trapping frequencies over the set is greater than 2ν, and further configured to apply excitation fields to the ions in the computational segments so as to cause the groups of the adjacent ions in the computational segments to carry out quantum operations; and
a controller, configured to receive a definition of a quantum computation comprising a sequence of computing steps, each step comprising multiple quantum operations to be performed in parallel, and to control the radiation source:
to segment the array into first computational segments by optically confining first barrier ions;
to apply the excitation fields to the ions in the first computational segments so as to cause the groups of the adjacent ions in the first computational segments to carry out the quantum operations in a first step in the sequence;
after completing the quantum operations in the first step, to reconfigure the array into second computational segments by optically confining second barrier ions, at least some of which are different from the first barrier ions, while retaining at least some coherence from the first computational segments to the second computational segments;
to apply the excitation fields to the ions in the second computational segments so as to cause the groups of the adjacent ions in the second computational segments to carry out the quantum operations in a second step in the sequence using at least some of the retained coherence; and
to repeat the steps of reconfiguring the array into further computational segments and applying the excitation fields to the further computational segments to complete the quantum computation.

102-103. (canceled)

104. The system according to claim 101, wherein the array of ions comprises a two-dimensional array of the ions.

105. (canceled)

106. The system according to claim 101, wherein optically confining the barrier ions comprises applying optical tweezers to the barrier ions using laser beams that are tuned to apply optical attractive forces or repulsive forces to the barrier ions.

107. (canceled)

108. The system according to claim 101, and comprising an array of detectors, wherein the controller is configured to perform a mid-circuit measurement by applying the radiation source and the detectors so sense a state of one or more of the barrier ions following at least the first step in the sequence and to use the information contained in the sensed state in the mid-circuit measurement in defining the quantum operations to be performed in subsequent steps.

109-113. (canceled)

114. The system according to claim 101, wherein applying the excitation fields comprises directing beams of coherent optical radiation to excite transitions of the ions in the computational segments,
wherein the controller is configured to set respective spectra of the beams and pulse times to drive the ions to complete the quantum operations in each step, and
wherein optically confining the barrier ions reduces a crosstalk between neighboring computational segments in the array.

115-118. (canceled)

119. The system according to claim 114, wherein the respective spectra and pulse times are chosen to compensate for an estimated crosstalk between the neighboring computational segments in the array,
wherein compensating for the estimated crosstalk decreases an infidelity of the quantum operations to less than 0.01.

120-124. (canceled)

125. The system according to claim 101, wherein optically confining the barrier ions reduces a rate of heating of the ions in the array, wherein the rate of heating is determined primarily by respective sizes of the computational segments, rather than by a number of the ions in the array.

126. (canceled)

127. The system according to claim 101, wherein the excitation fields excite motional modes of the array of ions having respective motional frequencies, and wherein optically confining the barrier ions groups the motional frequencies into bands having respective mean frequencies and bandwidths, such that the bandwidth of each band is no more than 10% of a difference between the mean frequencies of adjacent bands.

128-133. (canceled)

134. The system according to any of claim 101, wherein the controller is configured to cause the radiation source to apply the excitation fields so as to execute at least some of the quantum operations as multi-qubit gate operations executed over gates that comprise four or more of the ions.

135. (canceled)

136. The system according to claim 101, wherein reconfiguring the array into the second computational segments while retaining the at least some coherence comprises entangling the ions in the second computational segments with the ions in the first computational segments,
wherein the array comprises n ions, and wherein entangling the ions in the second computational segments comprises controllably entangling at least 70% of the ions in the computational segments in the array, without using mid-circuit measurements, over a number s of the reconfiguring steps such that s<0.2*n.

137-138. (canceled)

139. The system according to claim 101, wherein reconfiguring the array into the second computational segments is completed in a duration shorter than 1 ms.

140-152. (canceled)

153. The system according to claim 101, wherein segmenting the array gives rise to motional modes within the computational segments having respective vibrational frequencies grouped in frequency bands, with a minimal spacing Δf between the frequency bands, and wherein the controller is configured to drive the radiation source to apply the excitation fields so as to drive the ions to the target entanglement phases within a time that is less than 50/Δf.

154-200. (canceled)
